(19) United States
(12) Patent Application Publication
(10) Pub. No.: US 2024/0249230 A1
(43) Pub. Date: Jul. 25, 2024

(54) METHODS AND ELECTRONIC DEVICE FOR HANDLING SUSTAINABILITY GOAL SETTING IN PHYSICAL INFRASTRUCTURE

(71) Applicant: SMARTER DHARMA SUSTAINABLE SOLUTIONS, Bengaluru Urban, Bengaluru (IN)

(72) Inventors: Sriram KUCHIMANCHI, Vidyaranyapura (IN); Ifthikar ABOOBAKER JAVED, Vidyaranyapura (IN)

(73) Assignee: SMARTER DHARMA SUSTAINABLE SOLUTIONS, Bengaluru Urban, Bengaluru (IN)

(21) Appl. No.: 18/289,850

(22) PCT Filed: May 6, 2022
(86) PCT No.: PCT/IN2022/050443

§ 371 Date: Nov. 7, 2023

(30) Foreign Application Priority Data
May 7, 2021 (IN) 202141020792

(51) Int. Cl. G06Q 10/0637

(52) U.S. Cl. CPC G06Q 10/06375

(57) ABSTRACT

Accordingly, the embodiments herein disclose methods and systems (300) for handling a sustainability goal setting for a physical infrastructure by an electronic device (100). The method includes collecting one or more details of the physical infrastructure. Further, the method includes collecting a third party information associated with the physical infrastructure. Further, the method includes identifying the number of goals based on a type of the project and the geography associated with the project. The project is associated with the physical infrastructure. Further, the method includes determining an achievable value based on the collected details and the third party information. In an embodiment, the method further includes determining the maximum possible value for the goal. Furthermore, the method includes allowing the user of the electronic device (100) to edit the achievable goal value.

### CROSS REFERENCE TO RELATED APPLICATION

This application is based on and derives the benefit of Indian Provisional Application 202141020792, the contents of which are incorporated herein by reference.

### TECHNICAL FIELD

Embodiments disclosed herein relate to core features of a sustainability management system, and more particularly related to methods and systems for handling sustainability goal setting for a physical infrastructure.

### BACKGROUND

The current method for injecting sustainable design in a physical infrastructure is based on a manual approach and isn't a calculated and measured approach. The current method is tough to manage and hence it's mostly qualitative and the current method makes adoption of sustainability not a very comprehensive activity and ineffective when it comes to addressing climate change.

### OBJECTS

The principal object of the embodiments herein is to disclose methods and systems for handling sustainability goal setting for a physical infrastructure.

Another object of the embodiments herein is to collect/acquire one or more details associated with the physical infrastructure.

Another object of the embodiments herein is to collect/acquire one or more third party information associated with the physical infrastructure.

Another object of the embodiments herein is to identify a number of goals based on a type of a project and a geography associated with the project, where the project is associated with the physical infrastructure.

Another object of the embodiments herein is to determine an achievable value based on the collected/acquired details and the third party information.

Yet, another object of the embodiments herein is to disclose that an energy, water, carbon and waste are identified as potential sustainability goals to be presented to a user of an electronic device.

Yet, another object of the embodiments herein is to handle the sustainability goal setting for the physical infrastructure during climate change condition.

Yet, another object of the embodiments herein is to determine the maximum possible value for the goal.

Yet, another object of the embodiments herein is to allow a user of the electronic device to edit the achievable goal value.

### SUMMARY

Accordingly, the embodiments herein disclose methods and systems for handling a sustainability goal setting for a physical infrastructure. The method includes collecting/acquiring one or more details of the physical infrastructure. Further, the method includes collecting/acquiring a third party information associated with the physical infrastructure. Further, the method includes identifying a number of goals based on a type of a project and a geography associated with the project. The project is associated with the physical infrastructure. Furthermore, the method includes determining an achievable value based on the collected/acquired details and the third party information.

In an embodiment, the method further includes determining the maximum possible value for the goal. Furthermore, the method includes allowing the user of the electronic device to edit the achievable goal value.

In an embodiment, an energy, water, carbon and waste are identified as potential sustainability goals to be presented to a user of an electronic device.

In an embodiment, the method can be used to handle the sustainability goal setting in the physical infrastructure during climate change condition.

In an embodiment, the method includes monitoring, by the electronic device, the one or more details of the physical infrastructure and the third party information associated with the physical infrastructure over a period of time using the machine learning controller. Further, the method includes monitoring, by the electronic device (100), a feedback corresponding to the one or more details of the physical infrastructure and the third party information associated with the physical infrastructure. Further, the method includes determining, by the electronic device (100), the achievable action based on the monitored feedback corresponding to the one or more details of the physical infrastructure and the third party information associated with the physical infrastructure.

Accordingly, the embodiments herein disclose an electronic device for handling sustainability goal setting for a physical infrastructure. The electronic device includes a sustainability goal setting controller coupled with a processor and a memory. The sustainability goal setting controller is configured to acquire one or more details of the physical infrastructure and a third party information associated with the physical infrastructure. Further, the sustainability goal setting controller is configured to identify a number of goals based on a type of a project and a geography associated with the project, wherein the project is associated with the physical infrastructure. Further, the sustainability goal setting controller is configured to determine an achievable action based on the one or more acquired details of the physical infrastructure and the third party information associated with the physical infrastructure.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The embodiments disclosed herein are illustrated in the accompanying drawings, throughout which like reference letters indicate corresponding parts in the various figures. The embodiments herein will be better understood from the following description with reference to the drawings, in which:

FIG. 1 shows various hardware components of an electronic device for handling a sustainability goal setting for a physical infrastructure, according to embodiments as disclosed herein;

FIG. 2 shows various hardware components of a sustainability goal setting controller included in the electronic device, according to embodiments as disclosed herein;

FIG. 3 is an overview of a system for handling the sustainability goal setting for the physical infrastructure, according to embodiments as disclosed herein; and

FIG. 4 is a flow chart illustrating a method for handling the sustainability goal setting for the physical infrastructure, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods and systems for handling a sustainability goal setting for a physical infrastructure. The method includes collecting one or more details of the physical infrastructure. Further, the method includes collecting a third party information associated with the physical infrastructure. Further, the method includes identifying the number of goals based on a type of the project and the geography associated with the project. The project is associated with the physical infrastructure. Furthermore, the method includes determining an achievable value based on the collected details and the third party information.

Unlike conventional methods and systems, the proposed method can be used to determine the sustainability goal setting for the physical infrastructure in an automatic and dynamic manner. This results in enhancing the user experience. In the proposed method, financial and sustainability data is harnessed to minimize environmental impact and enhance the reputation of a business. The method can be used to reduce the resource wastage and increase efficiency in the utilization of energy, water and natural resources and materials in a better manner. The method can be used to achieve a green building design and contribute to a low-carbon future.

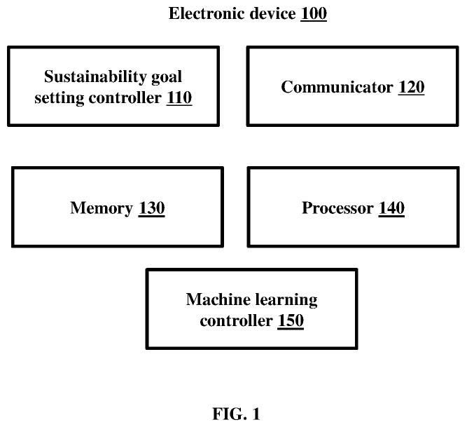

Referring now to the drawings, and more particularly to FIGS. 1 through 4, where similar reference characters denote corresponding features consistently throughout the figures, there are shown at least one embodiment.

FIG. 1 shows various hardware components of an electronic device (100) for handling a sustainability goal setting for a physical infrastructure, according to embodiments as disclosed herein. The electronic device (100) can be, for example, but not limited to a smart phone, a smart watch, a Personal Digital Assistant (PDA), a tablet computer, a laptop computer, a virtual reality device, an immersive system, an Internet of Things (IOT), a smart sensor, a drone, a smart vehicle or the like. The physical infrastructure can be, for example, but not limited to a construction site, real estate site, a building design, an agriculture land, a park, a hospital, a bus stand, a metro station, an airport or the like. The physical infrastructure can also be an existing building site and existing building operations and maintenance.

In an embodiment, the electronic device (100) includes a sustainability goal setting controller (110), a communicator (120), a memory (130), a processor (140) and a machine learning controller (150). The processor (140) is operated with the sustainability goal setting controller (110), the communicator (120), the memory (130) and the machine learning controller (150). The sustainability goal setting controller (110) can act as a sustainable resource platform.

The sustainability goal setting controller (110) is configured to acquire one or more detail associated with the physical infrastructure. The one or more detail can be, for example, but not limited to a location, size of a land, a total built area, a type of a building (e.g., residential, commercial, hybrid, hotel, restaurant or the like), a number of dwelling (e.g., houses/apartments/villas/villament, or the like), a number of rooms, a number of offices, a number of floors in the office, a number of floors in the building, a size of a dwellings (studio, one bedroom-hall-kitchen (1BHK), etc.,), total rooftop, total landscape area, bathroom fittings (faucets, flow-rates etc.,), electrical fittings, equipment's (dish washers, washing machines, etc.,), temperature details or the like. The details are provided by the user of the electronic device (100).

Further, the sustainability goal setting controller (110) is configured to deconstruct a design file uploaded by the user. In an example, if the user of the electronic device (100) uploads the design file about a project in the electronic device (100), the user of the electronic device (100) deconstructs the design file using a various tool (e.g., auto-cad, sketchup, etc.,) to obtain the one or more detail associated with the design file. Alternatively, the sustainability goal setting controller (110) reads on the design file from backend and collects the one or more detail associated with the design file.

Further, the sustainability goal setting controller (110) is configured to collect a third party information. In an embodiment, the third party information is collected based on a location information. The location information is driven from a latitude and longitude proximity of the physical infrastructure. Further, one or more online source (also called as data source) is available for collecting the third party information. The online source may be a paid online source, a non-paid online source (e.g., open-source or the like). The online source is used to provide a local policy information, a local resource availability information, usage patterns of resources from consumers (residents, office-goers, tenants, etc.,), what competition (in the vicinity) is doing or NOT doing, what the user has done or NOT done in the previous project (s). The local policy information can be for example, but not limited to a rain water harvesting mandate in the area, a solar water heating mandate in the area, a local resource challenge information like scarcity of water in the area based on groundwater availability (or lack thereof). In an example, the usage patterns could predict water paucity in the area from sources like water metering providers, water bills, etc.

In an embodiment, the third party information is collected based on the detail associated with the physical infrastructure using the machine learning controller (150).

Consider an example, if the user of the electronic device (100) enters an address for the project and the user of the electronic device (100) defines that they looking for local information around a radius of 5 Kilometers (KM) then, the electronic device (100) collects the all online sources around 5KM, wherein the online source includes the local policy information, the local resource availability information, the usage patterns of resources from consumers and any other relevant details associated with the projects. Further, the electronic device (100) displays the online resource information to the user.

Further, the sustainability goal setting controller (110) is configured to identify a number of goals based on a type of project and location of the project. The location corresponds to a geography (e.g., country, state or the like). For each goal, the sustainability goal setting controller (110) is configured to determine an achievable value based on the one or more detail associated with the physical infrastructure, the third party information and the online source. This is established as a maximum possible value for the goal. The user of the electronic device (100) would also allow to edit an achievable goal value. However, the user of the electronic device (100) can only edit within the maximum possible value for the goal.

In an example, the scientifically determining goal is critical for holistic sustainability adoption. The scientifically determining goal cannot be achieved without full information about the physical infrastructure, the location of the physical infrastructure, government policy mandates associated with the physical infrastructure and resource challenges associated with the physical infrastructure. Once the physical infrastructure, the location of the physical infrastructure, the government policy mandates associated with the physical infrastructure and the resource challenges associated with the physical infrastructure are available, either from the users or derived from the online source, the sustainability goal setting controller (110) is configured to compute all this data to determine the maximum possible value for the goal.

In an example, if there is a project with the basic information: Bangalore, Devanahalli, Residential, 1000 apartments (different sizes and customization). The basic information is collected from the user. Further, based on the basic information, the user of the electronic device (100) determines the following, but not limited to, expected occupancy of the community (e.g., apartments, support staff, visitors, etc.,), daily energy needed, water usage in the project, waste generated in the project, common area energy needs, landscape water needs, car wash water needs, daily hot water needs. This is done based on the experience of the user and certain standards in the country. The standard is defined by a local authority, state level authority, and a national level authority. In another embodiment, the standard is defined by a certification agency (e.g., green energy certification agency or the like). Based on the collected information, the user of the electronic device (100) allows us to deduce the total amount of energy needed daily for the community.

Further, the user of the electronic device (100) would be to identify all the solutions which are possible for the project. For instance, the location, size and geography of the project would give us information enough to say that a windmill setup wouldn't work. While, given that there are 1000 apartments, the user of the electronic device (100) makes a different decision. In an example, the user of the electronic device (100) identifies that there is enough daily waste generated so that wet waste is converted into biogas which can then be converted into electricity. This solution is identified and associated for the project. In another example, given the rooftop and other area around the project, the user of the electronic device (100) determines the amount of solar photovoltaic (PV) setup for renewable energy. The maximum possible would be deduced based on all the exclusions like rooftop tanks, gardens, etc.

In another example, the electronic device (100) deduces the maximum size of solar water heating setup to address the hot water need. The maximum possible would be deduced based on all the exclusions like rooftop tanks, gardens, etc. In another example, the lighting and other fixtures (like ceiling fans, air conditioners, motors, etc.,) are identified then, the electronic device (100) identifies the most efficient fixtures, so that the daily consumption can be reduced.

Further, the electronic device (100) finds out the policy requirements for the location (based on the address or the latitude and longitude (lat-long) information) of the project like—rain water harvesting mandate, solar PV Rooftop installation mandate, percentage of sewage water to be treated mandate, etc. This would be helping the user to set the minimum threshold for every element, including in-situ Energy (renewable) generation need.

Further, the electronic device (100) identifies the resource challenges at the location—which will tell the user to the urgency of energy, water or waste handling need at the location. For instance, first location (e.g., Devanahalli) doesn't have a water supply board supplying Cauvery water. This means that the community needs to be more self-dependent on water than a different community, say in a second location (e.g., Indiranagar).

Further, the electronic device (100) also collects the information about the usage of per capita energy, water in and around the location based on other projects data. This would tell the user whether the thresholds we have identified are fine or if we need to prepare for a different consumption pattern.

Further, the user of the electronic device (100) also monitors at nearby projects and identifies the solutions which have been installed or the challenges one has had trying to install such solutions. For instance, if there is a biogas plant installed nearby which is converting waste into energy, this makes us rank that solution higher as there is precedence too.

Based on all this information above, the following decisions are made by the user of the electronic device (100) (e.g., energy, water, carbon and waste are identified as potential sustainability goals to be presented, for each of these areas (for which goals are to be set), the maximum solution for each possible (within the constraints like available Rooftop, etc.,) is determined.

Further, the user of the electronic device (100) identifies the best combination of these solutions. For instance, if there is 10,000 square feet (sft) of rooftop available, the user of the electronic device (100) has options for maximum energy generation and maximum carbon footprint reduction, while safe-keeping the option of a rooftop garden for the community intact, which has its own sustainability value (for a different goal). This would mean a breakup like 4,500 sft for Solar PV and 3,500 sft for Solar WH and 2,000 sft for rooftop garden.

Based on the determined information or collected information, the user of the electronic device (100) determines the total maximum possible goal value. For instance, for energy, the goal would be off-grid energy generated. This would be a calculation of the maximum possible while combining the impact of the solutions identified earlier like (not limited to) Solar PV, Solar WH, Biogas to Electricity, etc.

The various determination isn't simply adding up the maximum of each, but a realistic maximum which is explained in the various cases. The maximum value becomes the goal for energy.

Further, the processor (140) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) stores the location information, third party information and the online resource information. The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the plurality of modules may be implemented through an Artificial intelligence (AI) model. A function associated with AI model may be performed through the non-volatile memory, the volatile memory, and the processor (140). The processor (140) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

In another embodiment, the method can be implemented by using a machine learning model. The machine learning model can be, for example, but not limited to a linear regression model, a logistic regression model, a classification and regression tree (CART) model, a naïve bayes model, a k-Nearest Neighbors (KNN) model or the like.

Although the FIG. 1 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined together to perform same or substantially similar function in the electronic device (100).

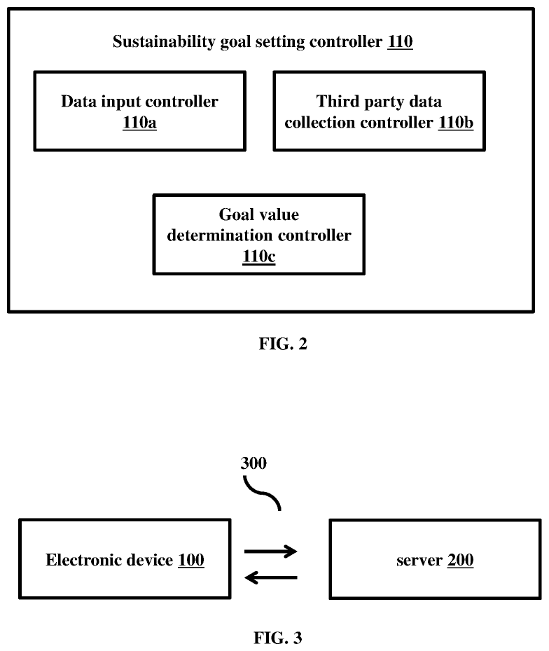

FIG. 2 shows various hardware components of the sustainability goal setting controller (110), according to embodiments as disclosed herein. The sustainability goal setting controller (110) includes a data input controller (110a), a third party data collection controller (110b) and a goal value determination controller (110c).

The data input controller (110a) is configured to collect the one or more detail associated with the physical infrastructure. The data input controller (110a) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the data input controller (110a) is configured to deconstruct the design file uploaded by the user to obtain the one or more details associated with the design file. Alternatively, the data input controller (110a) reads on the backend from the design file and collects the one or more detail associated with the design file.

Further, the third party data collection controller (110b) is configured to collect the third party information. In an embodiment, the third party information is collected based on the detail associated with the physical infrastructure using the machine learning controller (150). The third party data collection controller (110b) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the goal value determination controller (110c) is configured to identify the number of goals based on a type of project and location of the project. Further, the goal value determination controller (110c) is configured to determine the achievable value based on the one or more detail associated with the physical infrastructure, the third party information and the online source. This is established as a maximum possible value for the goal. The user of the electronic device (100) would also allowed to edit an achievable goal value. However, the user of the electronic device (100) can only edit within the maximum possible value for the goal.

The goal value determination controller (110c) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Although the FIG. 2 shows various hardware components of the sustainability goal setting controller (110) but it is to be understood that other embodiments are not limited thereon. In other embodiments, the sustainability goal setting controller (110) may include less or more number of components. Further, the labels or names of the components are used only for illustrative purpose and does not limit the scope of the invention. One or more components can be combined together to perform same or substantially similar function in the sustainability goal setting controller (110).

FIG. 3 is an overview of a system (300) for handling the sustainability goal setting in the physical infrastructure, according to embodiments as disclosed herein. In an embodiment, the system (300) includes the electronic device (100) and a server (200). The operations and functions of the electronic device (100) is already explained in the FIG. 1. In an embodiment, the server (200) is configured to collect the third party information and share the third party information with the electronic device (100) based on the requirement of the projects and the sustainability goals. The server (200) can be, for example, but not limited to a third party server, a cloud server, an edge server or the like.

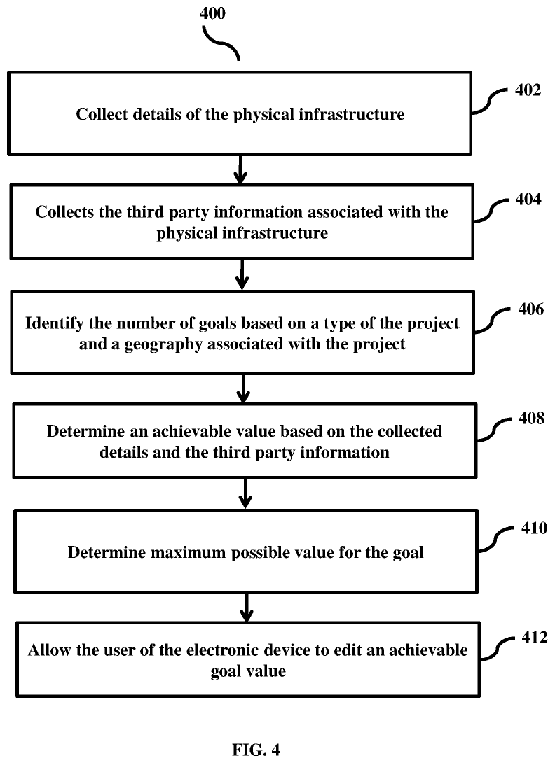

FIG. 4 is a flow chart (400) illustrating a method for handling the sustainability goal setting for the physical infrastructure, according to embodiments as disclosed herein. The operations (402-412) are performed by the sustainability goal setting controller (110).

At 402, the method includes collecting the details of the physical infrastructure. At 404, the method includes collecting the third party information associated with the physical infrastructure. At 406, the method includes identifying the number of goals based on a type of the project and the geography associated with the project. The project is associated with the physical infrastructure. At 408, the method includes determining the achievable value based on the collected details and the third party information. At 410, the method includes determining the maximum possible value for the goal. At 412, the method includes allowing the user of the electronic device (100) to edit the achievable goal value.

Unlike conventional methods, the proposed method can be used to determine the sustainability goal setting for the physical infrastructure in an automatic and dynamic manner. This results in enhancing the user experience. In the proposed method, harness financial and sustainability data to minimize environmental impact and enhance the reputation of a business. The method can be used to reduce the resource wastage and increase efficiency in the utilization of energy, water and natural resources and materials in a better manner. The method can be used to achieve a green building design and contribute to a low-carbon future.

The various actions in the flow chart (400) may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the elements. The elements shown in FIG. 1 and the FIG. 2 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method for handling sustainability goal setting for a physical infrastructure, comprising:
acquiring, by an electronic device (100), one or more details of the physical infrastructure;
acquiring, by the electronic device (100), a third party information associated with the physical infrastructure;
identifying, by the electronic device (100), a number of goals based on a type of a project and a geography associated with the project, wherein the project is associated with the physical infrastructure; and
determining, by the electronic device (100), an achievable action based on the one or more acquired details of the physical infrastructure and the third party information associated with the physical infrastructure.

2. The method as claimed in claim 1, comprises:
determining, by the electronic device (100), a maximum possible value for the number of goals based on the determined achievable action; and
allowing, by the electronic device (100), a user of the electronic device (100) to modify the achievable action based on the determined maximum possible value for the goal.

3. The method as claimed in claim 1, comprises:
identifying, by the electronic device (100), resource challenges at the physical infrastructure; and
determining, by the electronic device (100), another achievable action based on the one or more acquired details of the physical infrastructure, the third party information associated with the physical infrastructure and the identified resource challenges at the physical infrastructure.

4. The method as claimed in claim 1, comprises:
monitoring, by the electronic device (100), the one or more details of the physical infrastructure and the third party information associated with the physical infrastructure over a period of time using the machine learning controller (150);
monitoring, by the electronic device (100), a feedback corresponding to the one or more details of the physical infrastructure and the third party information associated with the physical infrastructure; and
determining, by the electronic device (100), the achievable action based on the monitored feedback corresponding to the one or more details of the physical infrastructure and the third party information associated with the physical infrastructure.

5. The method as claimed in claim 1, wherein the achievable action corresponds to control a usage of at least one of energy, water, carbon, waste and gas at the physical infrastructure, wherein the sustainability goal setting in the physical infrastructure is handled during climate change condition.

6. The method as claimed in claim 1, wherein the one or more details of the physical infrastructure comprises a location of the physical infrastructure, size of a land, a total built area, a type of a building, a number of dwelling, a number of rooms, a number of offices, a number of floors in the office, a number of floors in the building, a size of a dwellings, total rooftop, total landscape area, bathroom fittings, electrical fittings, equipment's used in the physical infrastructure temperature details associated with the physical infrastructure,

7. The method as claimed in claim 1, wherein the third party information is determined based on at least one of a location information of the physical infrastructure and a data source, wherein the third party information comprises a local policy information, a local resource availability information, and usage patterns of resources from consumers, wherein the third party information is determined based on a detail associated with the physical infrastructure using a machine learning controller (150).

8. An electronic device (100) for handling sustainability goal setting for a physical infrastructure, comprising:
a processor (140);
a memory (130); and
a sustainability goal setting controller (110), coupled with the processor (140) and the memory (130), configured to:
acquire one or more details of the physical infrastructure;
acquire a third party information associated with the physical infrastructure;
identify a number of goals based on a type of a project and a geography associated with the project, wherein the project is associated with the physical infrastructure; and
determine an achievable action based on the one or more acquired details of the physical infrastructure and the third party information associated with the physical infrastructure.

9. The electronic device (100) as claimed in claim 8, wherein the sustainability goal setting controller (110) is configured to:
determine a maximum possible value for the number of goals based on the determined achievable action; and
allow a user of the electronic device (100) to modify the achievable action based on the determined maximum possible value for the goal.

10. The electronic device (100) as claimed in claim 8, wherein the sustainability goal setting controller (110) is configured to:
identify resource challenges at the physical infrastructure; and
determine another achievable action based on the one or more acquired details of the physical infrastructure, the third party information associated with the physical infrastructure and the identified resource challenges at the physical infrastructure.

11. The electronic device (100) as claimed in claim 8, wherein the sustainability goal setting controller (110) is configured to:
monitor the one or more details of the physical infrastructure and the third party information associated with the physical infrastructure over a period of time using the machine learning controller (150);
monitor a feedback corresponding to the one or more details of the physical infrastructure and the third party information associated with the physical infrastructure; and
determine the achievable action based on the monitored feedback corresponding to the one or more details of the physical infrastructure and the third party information associated with the physical infrastructure.

12. The electronic device (100) as claimed in claim 8, wherein the achievable action corresponds to control a usage of at least one of energy, water, carbon, waste and gas at the physical infrastructure, wherein the sustainability goal setting in the physical infrastructure is handled during climate change condition.

13. The electronic device (100) as claimed in claim 8, wherein the one or more details of the physical infrastructure comprises a location of the physical infrastructure, size of a land, a total built area, a type of a building, a number of dwelling, a number of rooms, a number of offices, a number of floors in the office, a number of floors in the building, a size of a dwellings, total rooftop, total landscape area, bathroom fittings, electrical fittings, equipment's used in the physical infrastructure temperature details associated with the physical infrastructure,

14. The electronic device (100) as claimed in claim 8, wherein the third party information is determined based on at least one of a location information of the physical infrastructure and a data source, wherein the third party information comprises a local policy information, a local resource availability information, and usage patterns of resources from consumers, wherein the third party information is determined based on a detail associated with the physical infrastructure using a machine learning controller (150).
